(19) United States
(12) Patent Application Publication
(10) Pub. No.: US 2026/0280175 A1
(43) Pub. Date: Sep. 17, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Akiko SUZUKI, Mie (JP)

(21) Appl. No.: 19/168,809

(22) PCT Filed: Mar. 21, 2024
(86) PCT No.: PCT/JP2024/010939

§ 371 Date: Sep. 25, 2025

(30) Foreign Application Priority Data
Apr. 3, 2023 (JP) 2023-059923

(51) Int. Cl. H01R 13/424

(52) U.S. Cl. CPC H01R 13/424

(57) ABSTRACT

The purpose of the present invention is to disperse the force by which an electric wire is pressed against an exit opening edge part of a cavity in as wide an area as possible. A connector according to the present disclosure holds a terminal via a terminal holder and comprises: a terminal-equipped electric wire comprising an electric wire and a terminal attached to an end of the electric wire; a terminal holder having a cavity for accommodating the terminal; and a housing comprising a holder holding part for holding the terminal holder, and an electric wire guide part for guiding the electric wire extending from the holder holding part. The terminal holder has an exit opening edge part for extending the electric wire from the cavity. The exit opening edge part has a convex curved surface that curves while forming a curved surface from an inner peripheral surface of the cavity toward a direction intersecting an extension direction of the cavity.

### TECHNICAL FIELD

The present disclosure relates to a connector.

### BACKGROUND

Patent Document 1 discloses a connector provided with a socket housing and a socket connector including a plurality of socket terminals. Further, Patent Document 1 also discloses that the socket terminals fixed to linear conductors are inserted into terminal mounting holes of the socket housing.

### PRIOR ART DOCUMENT

### Patent Document

Patent Document 1: JP 2015-220184 A

### SUMMARY OF THE INVENTION

### Problems to be Solved

The linear conductor coming out from the socket housing is thought to be pulled in a direction intersecting an axial direction of the terminal mounting hole. In this case, the linear conductor is pressed against an opening edge part of the terminal mounting hole. In such a case, it is desired to disperse a force acting on the linear conductor in as wide a range as possible.

Accordingly, the present disclosure aims to disperse a force for pressing a wire against an exit opening edge part of a cavity in as wide a range as possible.

### Means to Solve the Problem

The present disclosure is directed to a connector for holding a terminal via a terminal holder, the connector being provided with a terminal-equipped wire including a wire and the terminal mounted on an end part of the wire, the terminal holder including a cavity for holding the terminal, and a housing including a holder holding portion for holding the terminal holder and a wire guiding portion for guiding the wire extending out from the holder holding portion, the terminal holder including an exit opening edge part for allowing the wire to extend out from the cavity, and the exit opening edge part having a convex curved surface bent while forming a curved surface extending from an inner peripheral surface of the cavity in a direction intersecting an extension direction of the cavity.

### Effect of the Invention

According to the present disclosure, a force for pressing a wire against an exit opening edge part of a cavity can be dispersed in as wide a range as possible.

### BRIEF DESCRIPTION OF THE DRAWINGS

FIG. 1 is a perspective view showing a connector according to one embodiment.

FIG. 2 is a perspective view showing the connector.

FIG. 3 is an exploded perspective view showing the connector.

FIG. 4 is an exploded perspective view showing the connector.

FIG. 5 is a section along V-V of FIG. 1.

FIG. 6 is an exploded perspective view showing a terminal module.

FIG. 7 is a perspective view partly in section of a housing.

FIG. 8 is a perspective view partly in section of the housing.

FIG. 9 is a section along IX-IX of FIG. 2.

FIG. 10 is a perspective view showing another connector different from the connector.

FIG. 11 is an exploded perspective view showing the other connector.

FIG. 12 is a section along XII-XII of FIG. 10.

FIG. 13 is a back view showing a terminal holder.

FIG. 14 is a section along IVX-IVX of FIG. 13.

FIG. 15 is a section along XV-XV of FIG. 13.

FIG. 16 is a section along XVI-XVI of FIG. 13.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector of the present disclosure is for holding a terminal via a terminal holder and provided with a terminal-equipped wire including a wire and the terminal mounted on an end part of the wire, the terminal holder including a cavity for holding the terminal, and a housing including a holder holding portion for holding the terminal holder and a wire guiding portion for guiding the wire extending out from the holder holding portion, the terminal holder including an exit opening edge part for allowing the wire to extend out from the cavity, and the exit opening edge part having a convex curved surface bent while forming a curved surface extending from an inner peripheral surface of the cavity in a direction intersecting an extension direction of the cavity.

According to this connector, if the wire is pulled, this wire can be pressed against the convex curved surface of the exit opening edge part. Since a contact area of the wire and the exit opening edge part can be increased by the convex curved surface, a force for pressing the wire against the exit opening edge part of the cavity can be dispersed in as wide a range as possible.

(2) In the connector of (1), the convex curved surface may be bent at a radius of curvature equal to or larger than an allowable bending radius of the wire.

In this way, the wire is hardly bent at a radius of curvature smaller than the allowable bending radius.

(3) In the connector of (1) or (2), the cavities may include a first cavity and a second cavity arranged in parallel, the exit opening edge parts may include a first exit opening edge part and a second exit opening edge part respectively corresponding to the first and second cavities, the terminal holder may further include a partition wall partitioning between the first and second cavities, the partition wall may include an exit-side partitioning edge part located between the first and second exit opening edge parts, the convex curved surface may be formed on a part of the first exit opening edge part side, out of the exit-side partitioning edge part, and the convex curved surface may have a larger radius of curvature than a part of the second exit opening edge part side, out of the exit-side partitioning edge part.

If an attempt is made to form the convex curved surfaces on both sides of the first and second exit opening edge parts of the exit opening edge parts, each convex curved surface region is reduced or the partition wall is thickened. If each convex curved surface region is reduced, a force dispersion range is narrowed. If the partition wall is thickened, it leads to the enlargement of the connector. Accordingly, focusing on a wire pull-out direction, the convex curved surface is formed on the part of the first exit opening edge part side, out of the exit-side partitioning edge part, if the wire extending out from the first exit opening edge part is guided toward the first exit opening edge part side. In this way, a force for pressing the wire against the exit-side partitioning edge part of the cavity can be dispersed in as wide a range as possible while the enlargement of the connector is suppressed.

(4) In the connector of any one of (1) to (3), the terminal holder may include a thickening portion for causing a part on the exit opening edge part side, out of the cavity, to project inwardly of the cavity, and the convex curved surface may be a curved surface extending from the thickening portion in a direction intersecting the extension direction of the cavity.

In this case, since the convex curved surface is a curved surface extending from the thickening portion in a wire guiding direction by the wire guiding portion, the convex curved surface is easily enlarged.

(5) In the connector of (4), the thickening portion may be formed in a region closer to the exit opening edge part than a region of the cavity where the terminal is arranged.

The region closer to the exit opening edge part than the region of the cavity where the terminal is arranged is a region where the wire passes. The wire is easily made thinner than a part to be connected to the wire, out of the terminal. Thus, if the thickening portion is formed in the region closer to the exit opening edge part than the region of the cavity where the terminal is arranged, the enlargement of the terminal holder is hardly caused.

(6) In the connector of any one of (1) to (5), the terminal holder may include a base holder and an intermediate holder to be overlapped on the base holder, each of the base holder and the intermediate holder may be formed with the cavity and the exit opening edge part, and the exit opening edge part of the intermediate holder may be located to be shifted from the exit opening edge part of the base holder in the extension direction of the cavities.

In this case, since a position where the wire extends out from the base holder and a position where the wire extends out from the intermediate holder are shifted in the extension direction of the cavities, those wires hardly interfere with each other. Thus, the wire extending out from the base holder is easily stably pressed against the convex curved surface of the base holder, and the wire extending out from the intermediate holder is easily stably pressed against the convex curved surface of the intermediate holder.

(7) In the connector of (6), the exit opening edge part of the intermediate holder may be located more outward than the exit opening edge part of the base holder in the extension direction of the cavities, the convex curved surface may be formed on a side opposite to the intermediate holder, out of the exit opening edge part of the base holder, and the convex curved surface may be formed on the base holder side, out of the exit opening edge part of the intermediate holder.

In this way, in the case of guiding the wires in the same direction as a direction from the intermediate holder toward the base holder, the wires respectively extending out from the intermediate holder and the base holder are easily stably pressed against the convex curved surfaces while interference is avoided.

(8) In the connector of (6) or (7), each of the exit opening edge part of the base holder and the exit opening edge part of the intermediate holder may be formed with the convex curved surface on a side in a direction intersecting both the extension direction of the cavities and an overlapping direction of the base holder and the intermediate holder.

In this way, in the case of guiding the wires in the direction intersecting both the extension direction of the cavities and the overlapping direction, the wires respectively extending out from the intermediate holder and the base holder are easily stably pressed against the convex curved surfaces while interference is avoided.

(9) In the connector of any one of (1) to (8), the convex curved surfaces may include a first convex curved surface and a second convex curved surface, and the first and second convex curved surfaces may be formed at positions different from each other in a circumferential direction of the exit opening edge part.

In this case, even if the wire is pulled out toward the first convex curved surface or pulled out toward the second convex curved surface, a force for pressing the wire against the exit opening edge part of the cavity can be dispersed in as wide a range as possible. In this way, regardless of in which of housings having different guiding directions the terminal holder is held, the force for pressing the wire against the exit opening edge part of the cavity can be dispersed in as wide a range as possible.

(10) In the connector of (9), the first and second convex curved surfaces may be arcuately connected when viewed from the exit opening edge part side along the extension direction of the cavity.

In this way, the wire can contact a connected part of the first and second convex curved surfaces in a larger contact area. Thus, the force for pressing the wire against the exit opening edge part of the cavity can be dispersed in a wider range.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

Hereinafter, a connector according to an embodiment is described.

### <Overall Structure>

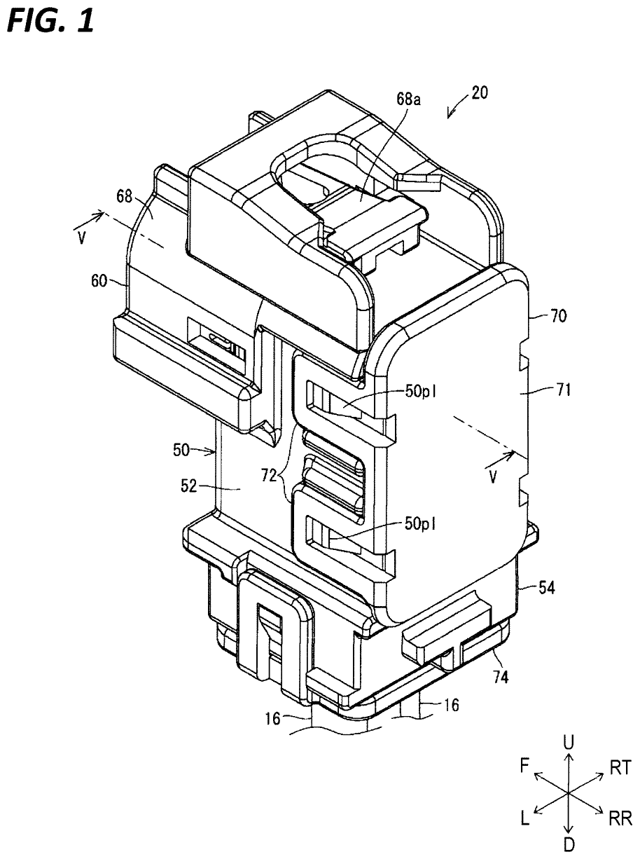

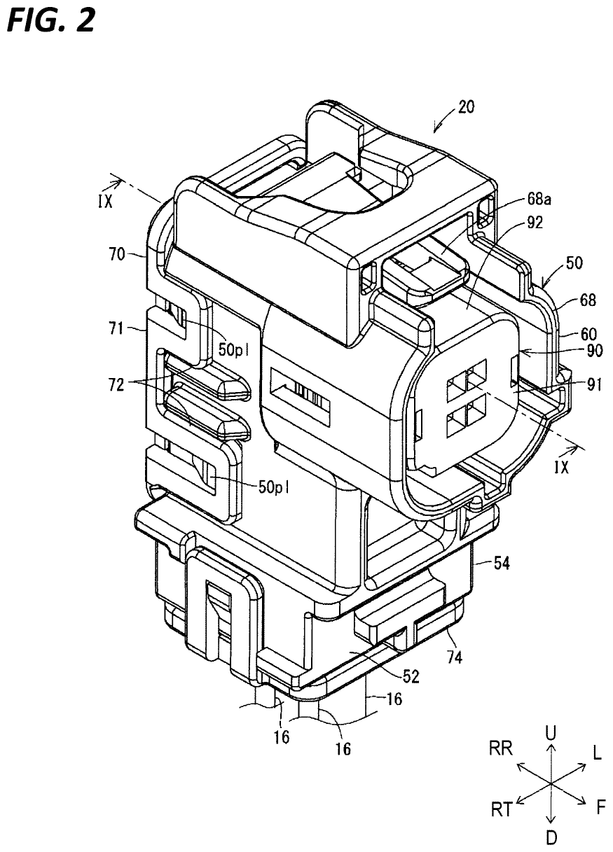

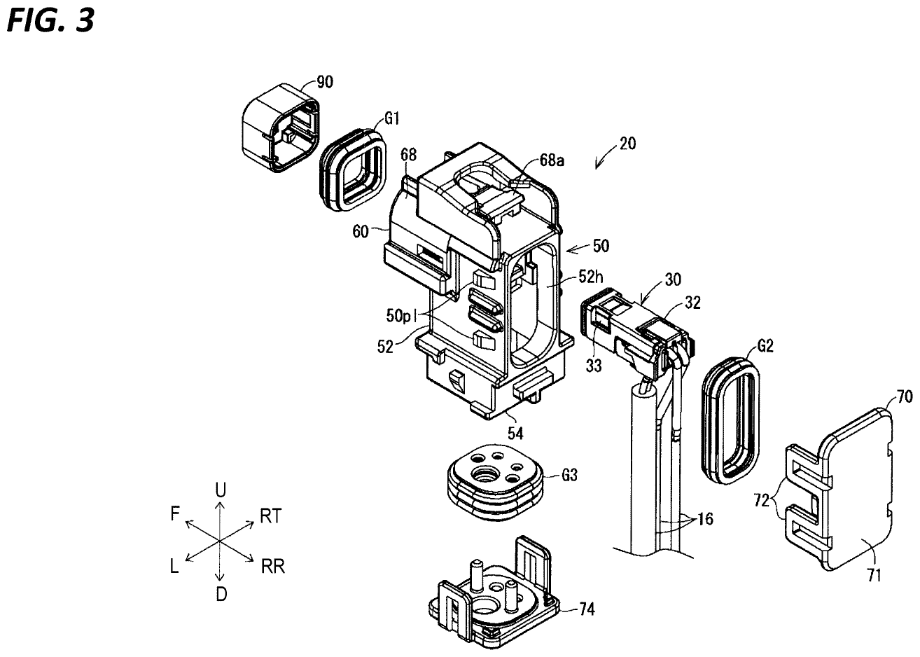

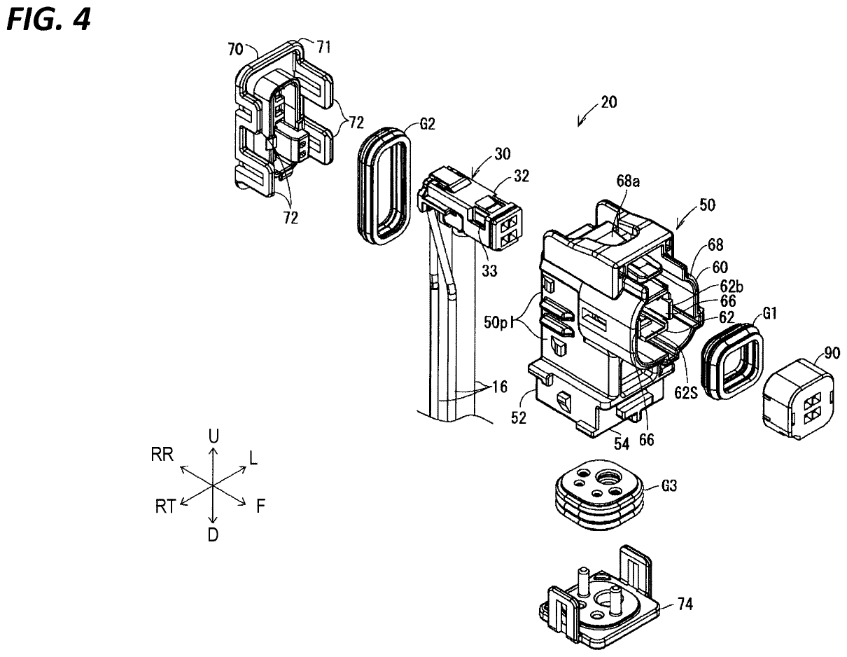

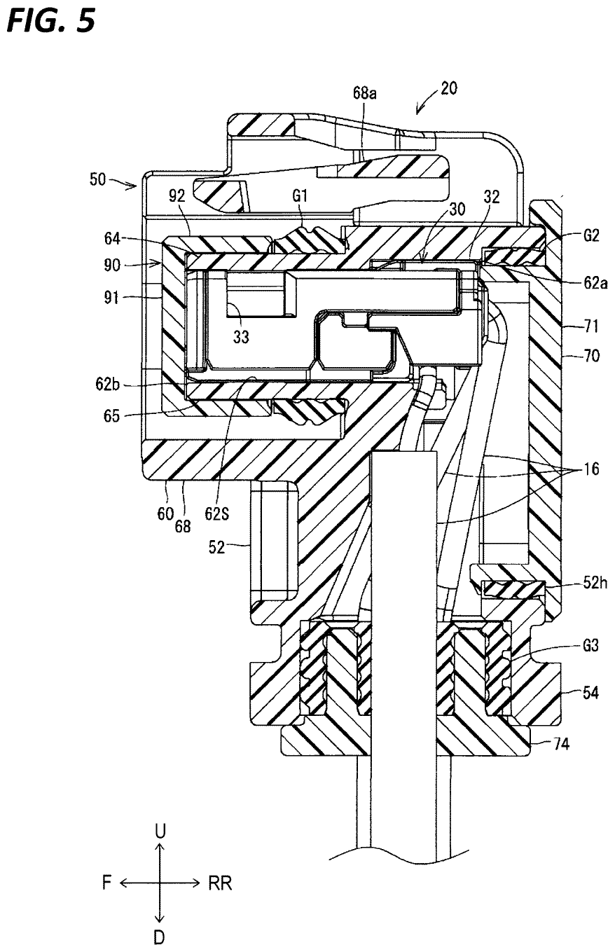

An overall structure of the connector is described. FIGS. 1 and 2 are perspective views showing a connector 20. FIGS. 3 and 4 are exploded perspective views showing the connector 20. FIG. 5 is a section along V-V of FIG. 1.

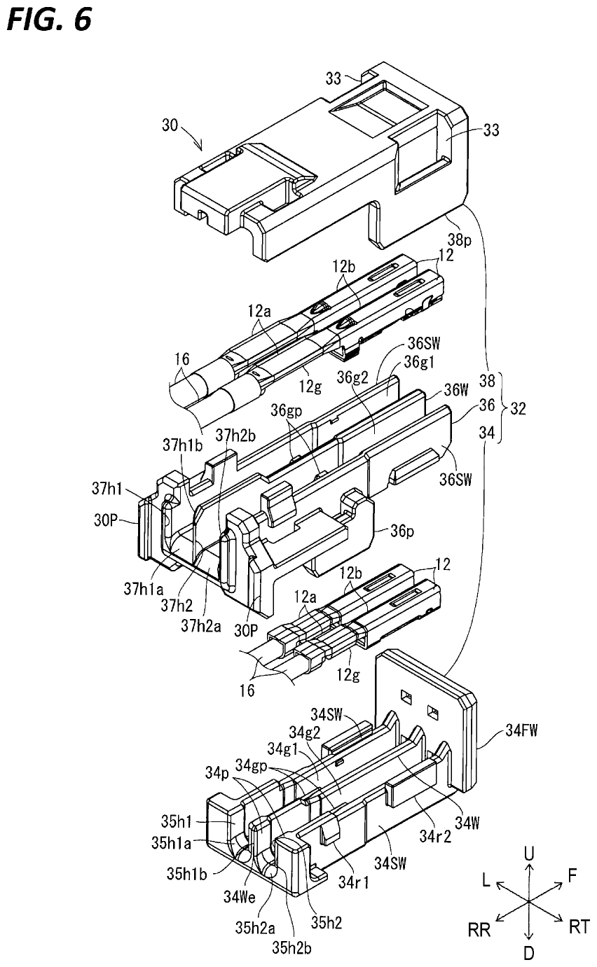

The connector 20 is a connector for holding terminals 12 via a terminal holder 32. The terminals 12 and the terminal holder 32 are described later with reference to FIG. 6 and the like. By connecting a mating connector to this connector 20, mating terminals of the mating connector are connected to the terminals 12.

The connector 20 is provided with terminal-equipped wires 11, the terminal holder 32 and a housing 50.

The terminal-equipped wire 11 includes a wire 16 and the terminal 12 mounted on an end part of the wire 16.

The terminals 12 are accommodated in the terminal holder 32. A terminal module 30 is constituted by the terminals 12 and the terminal holder 32 for accommodating the terminals 12. The wires 16 extend outward from the terminal holder 32. The terminals 12 are mounted into the housing 50 while being mounted in the terminal module 30.

The housing 50 holds the terminals 12 via the terminal holder 32. The housing 50 includes a holder holding portion 60 and a wire guiding portion 52. The terminal holder 32 is accommodated into the holder holding portion 60. The wire guiding portion 52 is integrally connected to the holder holding portion 60 and guides the wires 16 extending out from the holder holding portion 60. An extension direction of the wires 16 from the connector 20 is guided by the wire guiding portion 52.

Note that a retainer 90 is mounted into the holder holding portion 60. The terminal module 30 is held not to come out from the housing 50 by the retainer 90. In this embodiment, the retainer 90 is mounted into the housing 50 from a side opposite to a pull-out direction of the wires 16 from the terminal module 30. Such a retainer 90 may be called a front retainer.

The mating connector is connected to this connector 20 from the side opposite to the pull-out direction of the wires 16 from the terminal module 30. In the following description, for the sake of convenience, a side where the mating connector is connected may be referred to as a front side and an opposite side thereof may be referred to as a rear side. Further, a lock piece 68a for maintaining a connected state to the mating connector is located in the housing 50. For the sake of convenience, a side where the lock piece 68a is located with respect to the housing 50 may be referred to as an upper side and an opposite side thereof may be referred to as a lower side. Further, left and right sides may be referred to based on these front, rear, upper and lower sides.

The configuration of each component is described.

### <Concerning Terminal Module>

FIG. 6 is an exploded perspective view showing the terminal module 30. As shown in FIGS. 3 to 6, the terminal module 30 includes the terminals 12 and the terminal holder 32. The terminal 12 is a component formed, such as by press-working a metal plate, and includes a wire connecting portion 12a and a terminal connecting portion 12b. The wire connecting portion 12a and the terminal connecting portion 12b are, for example, linearly connected. The wire connecting portion 12a in one end part of the terminal 12 is connected to the end part of the wire 16 by crimping or the like. The terminal connecting portion 12b is, for example, formed into a tubular shape, and a pin-like or tab-like male connecting portion of the mating terminal is inserted and connected to the terminal connecting portion 12b.

In this embodiment, the terminal module 30 includes a plurality of the terminals 12. More specifically, the terminal module 30 includes four terminals 12. The four terminals 12 are so arranged that two terminals 12 are laterally arranged in each of two stages in a vertical direction. A plurality of the wires 16 extend out from the rear end of the terminal module 30. The number of the terminals 12 to be held by the terminal module 30 is arbitrary and the terminal module 30 may include only one, two or more terminals.

The terminal holder 32 is a resin component for holding the terminals 12. The terminal holder 32 holds the plurality of terminals 12 in a predetermined array while insulating the terminals 12 from each other. The terminal holder 32 is held in the housing 50 with the plurality of terminals 12 held by the terminal holder 32. In this way, the plurality of terminals 12 can be easily held in a predetermined array state in the housing 50.

More specifically, the terminal holder 32 includes a base holder 34, an intermediate holder 36 and a cover holder 38.

The base holder 34 is formed with a plurality of (here, two) cavities 34g1, 34g2. The cavities 34g1, 34g2 are arranged in parallel and open on upper and rear sides. A front wall 34FW stands on the front edge of the base holder 34. The terminals 12 are arranged into the cavities 34g1, 34g2 through upper and rear openings of the cavities 34g1, 34g2. The cavity 34g1 is an example of a first cavity, and the cavity 34g2 is an example of a second cavity. The base holder 34 may be formed with more cavities.

The base holder 34 includes a partition wall 34W and a pair of side walls 34SW. The partition wall 34W is a wall partitioning between the first and second cavities 34g1, 34g2. The pair of side walls 34SW are walls defining both outer sides of the cavities 34g1, 34g2.

A positioning protrusion 34gp projects on a bottom part of the cavity 34g1, 34g2. The terminal 12 includes a recess 12g recessed between a coating crimping portion to be crimped to a coating of the wire, out of the wire connecting portion 12a, and the terminal connecting portion 12b. By fitting the positioning protrusion 34gp into the recess 12g of the terminal 12, the terminal 12 is positioned in the positioning protrusion 34gp.

The intermediate holder 36 is a component spreading to such an extent as to be able to close the upper openings of the plurality of cavities 34g1, 34g2. The intermediate holder 36 includes locking pieces 36p lockable to locking protrusions 34r1 of the base holder 34.

With the upper openings of the plurality of cavities 34g1, 34g2 closed by the intermediate holder 36, the locking pieces 36p are locked to the locking protrusions 34r1 on both sides of the base holder 34, whereby the intermediate holder 36 is held in a state overlapped on the base holder 34. In this state, the terminals 12 in the cavities 34g1, 34g2 are restricted from moving upward, and the state where the positioning protrusions 34gp are fit in the recesses 12g is maintained.

The intermediate holder 36 includes a plurality of (here, two) cavities 36g1, 36g2 located on a side opposite to the base holder 34. The cavities 36g1, 36g2 are arranged in parallel and open on upper and rear sides. With the intermediate holder 36 united with the base holder 34, the front wall 34FW of the base holder 34 is located forward of front openings of the cavities 36g1, 36g2. The terminals 12 are arranged into the cavities 36g1, 36g2 through upper and rear openings of the cavities 36g1, 36g2.

The cavity 36g1 is an example of the first cavity, and the cavity 36g2 is an example of the second cavity. The base holder 34 may be formed with more cavities.

The intermediate holder 36 includes a partition wall 36W and a pair of side walls 36SW. The partition wall 36W is a wall partitioning between the first and second cavities 36g1, 36g2. The pair of side walls 36SW are walls defining both outer sides of the cavities 36g1, 36g2.

A positioning protrusion 36gp projects on a bottom part of the cavity 36g1, 36g2. By fitting the positioning protrusion 36gp into the recess 12g of the terminal 12, the terminal 12 is positioned in the positioning protrusion 36gp.

If the terminal holder 32 is provided with a plurality of the intermediate holders 36, the terminal holder 32 can hold the terminals 12 in three or more stages in the vertical direction.

The cover holder 38 is a component spreading to such an extent as to be able to close the upper openings of the plurality of cavities 36g1, 36g2. The cover holder 38 includes locking pieces 38p lockable to locking protrusions 34r2 of the base holder 34.

With the upper openings of the plurality of cavities 36g1, 36g2 closed by the cover holder 38, the locking pieces 38p are locked to the locking protrusions 34r2 on the both sides of the base holder 34 beyond the outside of the intermediate holder 36. In this way, the cover holder 38 is held in a state united with the base holder 34 with the intermediate holder 36 arranged between the base holder 34 and the cover holder 38. In this state, the terminals 12 in the cavities 36g1, 36g2 are restricted from moving upward, and the state where the positioning protrusions 36gp are fit in the recesses 12g is maintained.

With the plurality of terminals 12 held by the terminal holder 32, the plurality of wires 16 extend out from the rear openings of the cavities 34g1, 34g2, 36g1 and 36g2.

Out of the terminal holder 32, opening edge parts, through which the wires 16 extend out from the cavities 34g1, 34g2, are exit opening edge parts 35h1, 35h2 on the side of the base holder 34. The exit opening edge part 35h1 is an edge part corresponding to the first cavity 34g1 of the base holder 34, and the first exit opening edge part 35h1 on the side of the base holder 34 located on the rear edge of the first cavity 34g1. The exit opening edge part 35h2 is an edge part corresponding to the second cavity 34g2 of the base holder 34, and the second exit opening edge part 35h2 on the side of the base holder 34 located on the rear edge of the second cavity 34g2.

Out of the terminal holder 32, opening edge parts, through which the wires 16 extend out from the cavities 36g1, 36g2, are exit opening edge parts 37h1, 37h2 on the side of the intermediate holder 36. The exit opening edge part 37h1 is an edge part corresponding to the first cavity 36g1 of the intermediate holder 36, and the first exit opening edge part 37h1 on the side of the intermediate holder 36 located on the rear edge of the first cavity 36g1. The exit opening edge part 37h2 is an edge part corresponding to the second cavity 36g2 of the intermediate holder 36, and the second exit opening edge part 37h2 on the side of the intermediate holder 36 located on the rear edge of the second cavity 36g2.

Further, the front wall 34FW is formed with through holes, through which the mating terminals can pass. Each of the plurality of mating terminals is connected to the corresponding terminal 12 through the through hole.

Locking recesses 33, to which locking lances 66 are lockable, are formed in the side surfaces of the terminal holder 32. In this embodiment, a rectangular hole penetrating in an in-out direction is formed in a base end part of the locking piece 38p of the cover holder 38, and this hole is the locking recess 33. A recess, to which a locking lance is locked, may be a bottomed recess.

Configurations relating to the exit opening edge parts 35h1, 35h2, 37h1 and 37h2 are described in more detail later.

### <Concerning Housing>

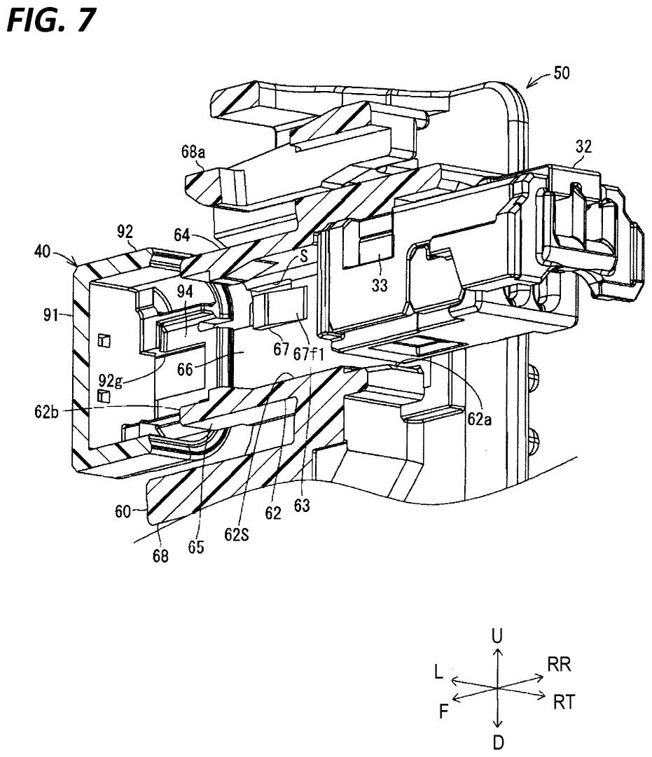

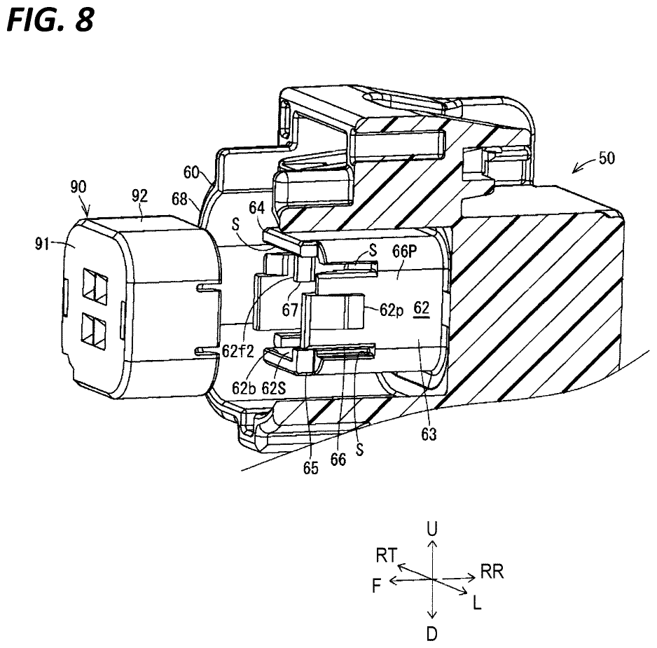

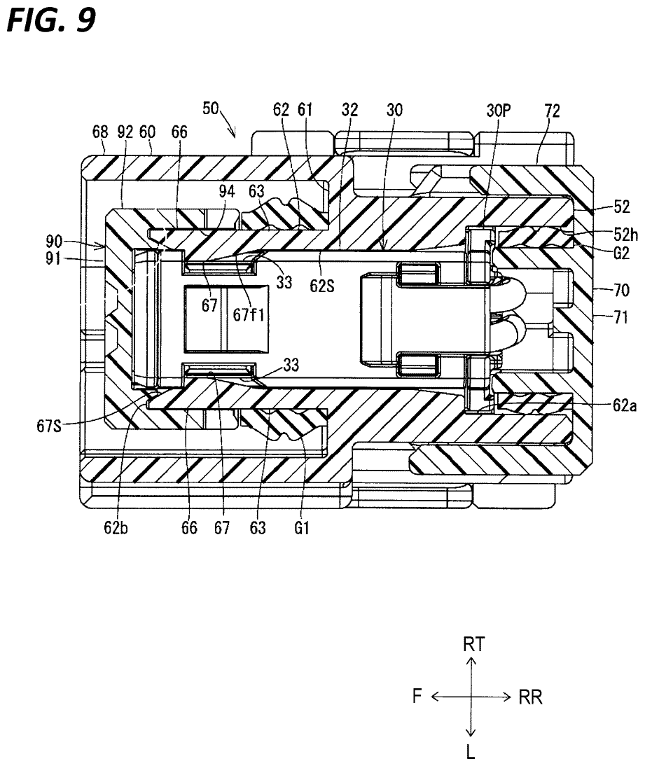

FIGS. 7 and 8 are perspective views partly in section of the housing 50. FIG. 9 is a section along IX-IX of FIG. 2. In FIG. 9, the terminal module 30 is drawn not as a section, but as a plan view.

As shown in FIGS. 1 to 5 and 7 to 9, the housing 50 is a molded component made of resin or the like. As described above, the housing 50 is provided with the holder holding portion 60 and the wire guiding portion 52.

The holder holding portion 60 is a part for holding the terminals 12 by holding the terminal module 30. Further, the holder holding portion 60 is a part to be connected to the mating connector while holding the terminals 12.

In this embodiment, the holder holding portion 60 is provided with an accommodation wall portion 62 and an outer wall portion 68.

The accommodation wall portion 62 is formed into a tubular shape to surround the terminal module 30. The outer wall portion 68 is formed into a tubular shape to surround a front part of the accommodation wall portion 62 while being spaced apart therefrom. In this embodiment, the accommodation wall portion 62 and the outer wall portion 68 are in the form of rectangular tubes. Here, the rectangular tube may be not only a rectangular tube with right-angle corners, but also a rectangular tube with rounded corners.

Out of the accommodation wall portion 62, a rear opening is a first opening 62a and a front opening is a second opening 62b. The terminal module 30 is arranged in the accommodation wall portion 62 with the wires 16 pulled out through the first opening 62a.

An intermediate part in an extension direction of the accommodation wall portion 62 and a rear end part of the outer wall portion 68 are connected via a coupling wall 61. That is, the coupling wall 61 is located in the intermediate part in the extension direction of the accommodation wall portion 62, and a part of the accommodation wall portion 62 forward of the coupling wall 62 forms a double wall together with the outer wall portion 68.

The front part of the accommodation wall portion 62 and the outer wall portion 68 are parts to be connected to the mating connector. A tubular part of the mating connector can enter between the front part of the accommodation wall portion 62 and the outer wall portion 68. Thus, connected parts of the terminals 12 and the mating terminals are surrounded by the accommodation wall portion 62, the tubular part of the mating connector and the outer wall portion 68. In this way, water cut-off performance and protection performance of the terminal connected parts are enhanced. Further, an annular resilient member G1 can be interposed between the accommodation wall portion 62 and the tubular part of the mating connector, whereby the water cut-off performance for the connected parts is enhanced.

The lock piece 68a to be locked to the mating connector is formed in a circumferential part (upper part) of the outer wall portion 68.

A rear part of the accommodation wall portion 62 is formed to be thicker than the front part, and extends further rearward than the rear end of the outer wall portion 68.

The holder holding portion 60 includes the locking lances 66. The locking lance 66 is formed to be resiliently deformable with a base end connected to the accommodation wall portion 62 as a fulcrum. The locking lance 66 includes a locking protrusion 67 lockable to the terminal module 30 in the accommodation wall portion 62 by projecting inwardly of the accommodation wall portion 62.

The locking lance 66 is formed to be resiliently deformable inward and outward of the accommodation wall portion 62. The locking protrusion 67 of the locking lance 66 projects inwardly of the accommodation wall portion 62 in an initial state. When the terminal module 30 is inserted into the accommodation wall portion 62, the locking lances 66 are resiliently deformed outward to allow the insertion of the terminal module 30. With the terminal module 30 accommodated in the accommodation wall portion 62, the locking lances 66 return to original positions on an inner peripheral side by resilient forces. In this way, the locking protrusions 67 can be locked to the terminal module 30.

More specifically, the front part of the accommodation wall portion 62 includes a pair of side walls 63, an upper wall 64 and a lower wall 65. The pair of side walls 63, the upper wall 64 and the lower wall 65 are connected to form a rectangular tube.

The upper and lower walls 64, 65 extend further forward than the pair of side walls 63. The plate-like locking lances 66 extend from the front edges of the pair of side walls 63.

The locking lance 66 is formed to be resiliently deformable inward and outward of the accommodation wall portion 62. In this embodiment, the locking lance 66 is in the form of a plate extending forward from the front edge of the side wall 63. Slits S are formed along a front-rear direction between the upper edge of the locking lance 66 and the upper wall 64 and between the lower edge of the locking lance 66 and the lower wall 65. Thus, the locking lance 66 can be resiliently deformed inward and outward of the accommodation wall portion 62 with a base end 66P on a rear end side connected to the side wall as a fulcrum. That is, the locking lance 66 is supported in a cantilever manner to extend toward the front side (toward the second opening 62b) opposite to a side where the wires 16 extend out from the accommodation wall portion 62 along an axial direction of the accommodation wall portion 62.

The locking protrusion 67 is a part projecting toward a terminal component accommodation space 62S, out of the locking lance 66. In this embodiment, the locking protrusion 67 partially projects in a width direction of the locking lance 66. More specifically, the locking protrusion 67 is formed in an upper part of the inner surface of the locking lance 66. The locking protrusion 67 is formed at a position to be fit into the locking recess 33 of the terminal module 30 with the terminal module 30 accommodated in the accommodation wall portion 62. The locking protrusion 67 has a guide surface 67f1 for gradually reducing a projecting dimension toward a rear side. In inserting the terminal module 30 into the accommodation wall portion 62, the terminal module 30 is pressed against the guide surface 67f1, whereby the locking protrusion 67 can be moved outward. The locking lance 66 returns to an initial shape and is fit into the locking recess 33 of the terminal module 30, whereby the terminal module 30 is restricted in position so as not to come out rearward.

The wire guiding portion 52 is a part integrally molded of resin together with the holder holding portion 60. The wire guiding portion 52 is formed into a rectangular tube shape. An upper end part of the wire guiding portion 52 is connected to a rear end side of the accommodation wall portion 62. The wire guiding portion 52 extends downward from a part connected to the rear end side of the accommodation wall portion 62. An internal space of the wire guiding portion 52 is formed to extend downward from behind the terminal module 30. The wires 16 extending out from the terminal module 30 are bent downward in an upper internal space of the wire guiding portion 52 behind the terminal module 30. The wires 16 are further led out downward through the inside of the wire guiding portion 52.

A setting opening 52h is formed in a rear part of the wire guiding portion 52.

Since the setting opening 52h is open rearward of the accommodation wall portion 62, the terminal module 30 is easily set into the accommodation wall portion 62 through this setting opening 52h. Further, the setting opening 52h is open along a wire pull-out direction of the wires 16 from behind to below the accommodation wall portion 62. Thus, during a setting operation of the terminal module 30, the wires 16 extending out from the terminal module 30 can be pulled out from the housing 50 through the setting opening 52h. Thus, a routing space for the wires 16 is easily ensured during the setting operation of the terminal module 30.

The setting opening 52h is closed by a cover member 70. The cover member 70 is a component integrally molded of resin. The cover member 70 includes a plate-like cover body 71 for closing the setting opening 52h and locking pieces 72 extending out from the cover member 70. With the setting opening 52h closed by the cover body 71, locking protrusions 50p1 on the outer side surfaces of the housing 50 are locked into locking holes of the locking pieces 72. In this way, the cover member 70 is united with the housing 50 while closing the setting opening 52h.

An annular resilient member G2 for closing a gap between the inner peripheral edge of the setting opening 52h and the cover member 70 may be arranged between the inner peripheral edge of the setting opening 52h and the cover member 70.

Out of the wire guiding portion 52, a lower end part on a side opposite to the holder holding portion 60 is formed into an entirely surrounded pull-out end part 54. The wires 16 are pulled out to outside through the wire guiding portion 52 and further through this pull-out end part 54.

A rubber plug G3 may be mounted into the pull-out end part 54 and the wires 16 may be inserted through insertion holes formed in the rubber plug G3. In this way, water intrusion along the wires 16 is suppressed. The rubber plug G3 may be pressed from outside by a pressing member 74 so as not to come out from the pull-out end part 54.

In this embodiment, an example in which the wire guiding portion 52 guides the wires 16 downward is described. The wire guiding portion 52 may guide the wires 16 in another direction. For example, the wire guiding portion 52 may guide the wires 16 straight rearward, rightward, leftward or upward. An example of a housing in which a wire guiding portion extends out from a holder holding portion in a horizontal direction, more specifically in a rightward direction, is described later.

### <Concerning Retainer>

As shown in FIGS. 2 to 5 and 7 to 9, the retainer 90 is a member for restricting the resilient deformation of the locking lances 66. More specifically, the retainer 90 restricts outward deformation of the locking lances 66. With the locking lances 66 locked to the terminal module 30, the locking lances 66 are restricted from being deformed outward by the retainer 90. In this way, the terminal module 30 is suppressed from coming out from the accommodation wall portion 62.

The retainer 90 is a component molded of resin or the like. In this embodiment, the retainer 90 is mounted in an end part on the side of the second opening 62b on the front side of the accommodation wall portion 62.

More specifically, the retainer 90 includes a front wall 91 and a peripheral wall 92.

The front wall 91 is in the form of a plate arrangeable to close the second opening 62b. Through holes, through which the mating terminals can pass, are formed at positions corresponding to the respective terminals 12 in the front wall 91.

The peripheral wall 92 is in the form of a rectangular tube surrounding the outer peripheral surface of a front end part of the accommodation wall portion 62. Mounting recesses 92g are formed in the inner surfaces of left and right wall parts of the peripheral wall 92 (see FIG. 7). In this embodiment, mounting protrusions 62p are formed on the outward facing surfaces of the locking lances 66 (see FIG. 8). The mounting protrusions may be formed on the outer surface of the accommodation wall portion 62. If the retainer 90 is externally fit to the tip of the accommodation wall portion 62, the mounting protrusions 62p are fit into the mounting recesses 92g. In this way, the retainer 90 is mounted on the front end part of the accommodation wall portion 62 in a state where the peripheral wall 92 surrounds the outer peripheral surface of the front end part of the accommodation wall portion 62 and the front wall 91 is arranged in front of the accommodation wall portion 62.

The retainer 90 includes restricting portions 94 located outside the locking lances 66 to restrict outward movements of the locking lances 66. In this embodiment, parts, which are the inner surfaces of the left and right wall parts of the peripheral wall 92 and adjacent to the mounting recesses 92g, are the restricting portions 94. With the retainer 90 mounted on the front end part of the accommodation wall portion 62, the restricting portions 94 are arranged at positions facing the outward facing surfaces of the locking lances 66. Here, the restricting portions 94 are arranged at positions facing the outward facing surfaces of tip parts of the locking lances 66.

The restricting portion 94 and the locking lance 66 may be in contact. A gap may be formed between the restricting portion 94 and the locking lance 66 within a range that the locking of the locking protrusion 67 to the locking recess 33 cannot be released. This gap is preferably set to be as small as possible.

### <Holding Structure for Terminal Module>

If the terminal module 30 is inserted into the accommodation wall portion 62 from behind, the front end edge of the terminal module 30 contacts the guide surfaces 67f1 of the locking protrusions 67 and displace the locking lances 66 outward. If the front end edge of the terminal module 30 moves beyond the locking protrusions 67, the locking lances 66 return to the original shape due to their resilient forces and the locking protrusions 67 are fit into the locking recesses 33. In this way, the terminal module 30 is prevented from coming out rearward.

Further, a protrusion 30P on the rear end of the terminal module 30 contacts the rear end part of the accommodation wall portion 62, whereby a forward movement of the terminal module 30 is restricted (see FIG. 9).

Thereafter, the retainer 90 is mounted on the front end part of the accommodation wall portion 62. Then, the restricting portions 94 face the outward facing surfaces of the locking lances 66. In this way, outward movements of the tip parts of the locking lances 66 are restricted and the locking protrusions 67 hardly move outward away from the locking recesses 33.

### <Concerning Wire Guiding Direction>

The wire guiding portion 52 of the above housing 50 extends downward with respect to the holder holding portion 60. The terminal module 30 may be mounted into a housing for guiding the wires 16 in a direction different from the housing 50.

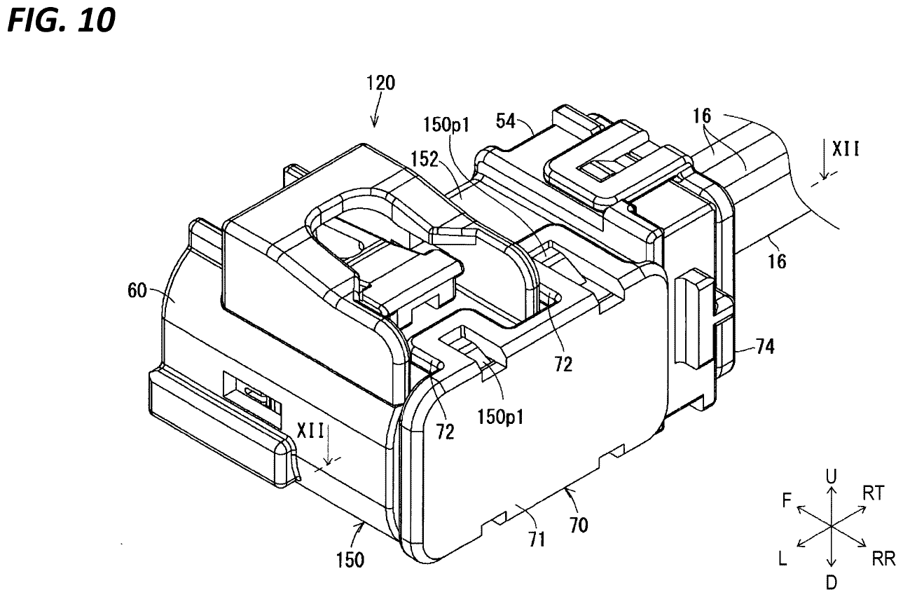

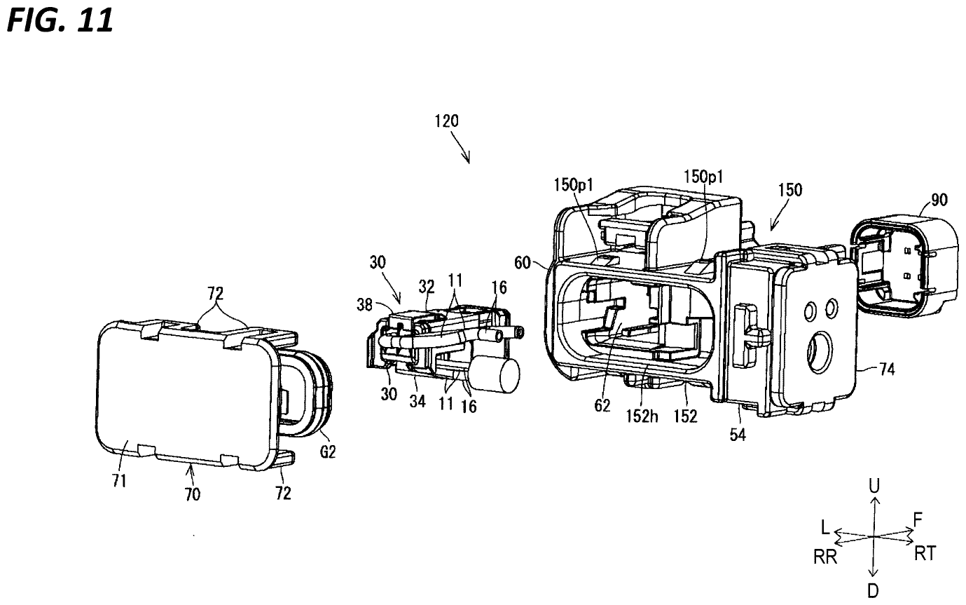

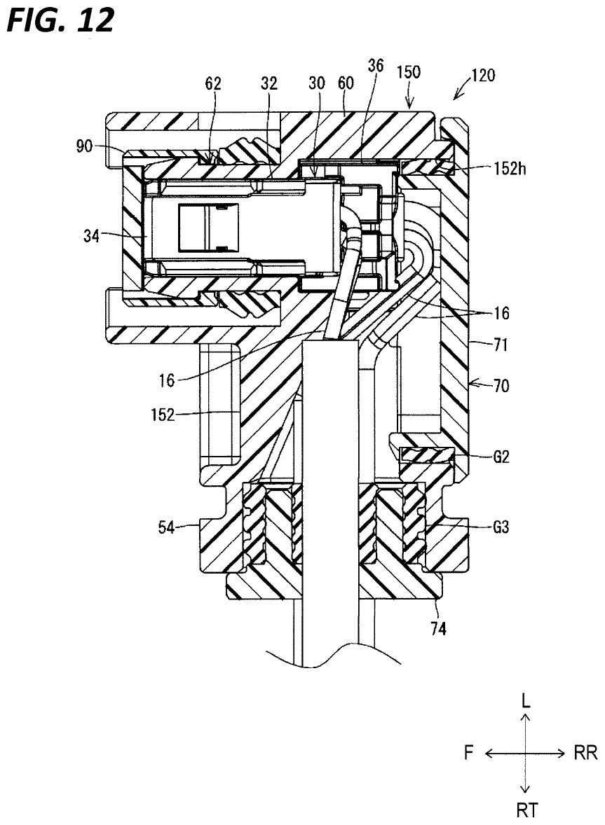

FIG. 10 is a perspective view showing a connector 120 different from the connector 20. FIG. 11 is an exploded perspective view showing the connector 120. FIG. 12 is a section along XII-XII of FIG. 10. This connector 120 is configured to guide wires 16 in a lateral direction with respect to a terminal module 30.

This connector 120 is described, centering on points of difference from the connector 20.

The connector 120 is provided with terminal-equipped wires 11, a terminal holder 32 and a housing 150.

The terminal-equipped wires 11 and the terminal holder 32 are the same as the terminal-equipped wires 11 and the terminal holder 32 described with respect to the connector 20. Thus, the terminal module 30 is used as a component common to the connectors 20 and 120.

A retainer 90 may also be the same as the retainer 90 described with respect to the connector 20.

The housing 150 is provided with a holder holding portion 60 and a wire guiding portion 152. The holder holding portion 60 may be a part having the same shape as the holder holding portion 60 described with respect to the connector 20.

The wire guiding portion 152 is a part integrally molded of resin together with the holder holding portion 60 and in the form of a rectangular tube, similarly to the wire guiding portion 52.

Unlike the wire guiding portion 52, the wire guiding portion 152 extends in a horizontal direction and one end part (left end part) thereof is connected to a rear end side of an accommodation wall portion 62. Thus, the wire guiding portion 152 extends in the horizontal direction from a part connected to the rear end side of the accommodation wall portion 62. An internal space of the wire guiding portion 152 is formed to extend rightward along the horizontal direction from behind the terminal module 30. The wires 16 extending out from the terminal module 30 are bent rightward in the internal space of one end part (left end part) of the wire guiding portion 152 behind the terminal module 30. The wires 16 are further led out rightward to outside through the inside of the wire guiding portion 152.

That is, the housings 50, 150 guide the wires 16 extending out from the terminal module 30 in the directions intersecting the extension direction of the terminals 12, but guiding directions are different. The housing 50 guides the wires 16 toward the base holder 34 along a stacking direction of the intermediate holder 36 on the base holder 34. The housing 150 guides the wires 16 in an arrangement direction of first cavities 34g1, 36g1 and second cavities 34g2, 36g2 (see FIG. 6).

A setting opening 152h is formed in a rear part of the wire guiding portion 152, similarly to the wire guiding portion 52.

Since the setting opening 152h is open in a rear part of the accommodation wall portion 62, the terminal module 30 is easily set into the accommodation wall portion 62 through this setting opening 152h. Further, the setting opening 152h is open along a pull-out direction of the wires 16 along the horizontal direction from behind the accommodation wall portion 62. Thus, during a setting operation of the terminal module 30, the wires 16 extending out from the terminal module 30 can be pulled out from the housing 150 through the setting opening 152h. Thus, a routing space for the wires 16 is easily ensured during the setting operation of the terminal module 30.

The setting opening 152h is closed by a cover member 70. This cover member 70 may be the same as the cover member 70 described with respect to the connector 20. With the setting opening 152h closed by a cover body 71, locking protrusions 150p1 on the outer side surfaces of the housing 150 are locked into locking holes of locking pieces 72. In this way, the cover member 70 is united with the housing 150 while closing the setting opening 152h.

An annular resilient member G2 for closing a gap between the inner peripheral edge of the setting opening 152h and the cover member 70 may be arranged between the inner peripheral edge of the setting opening 152h and the cover member 70.

Out of the wire guiding portion 152, a lower end part on a side opposite to the holder holding portion 60 is formed into an entirely surrounded pull-out end part 54, similarly to the wire guiding portion 52. The wires 16 are pulled out to outside through the wire guiding portion 152 and further through this pull-out end part 54.

A rubber plug G3 may be mounted into the pull-out end part 54 and the wires 16 may be inserted through insertion holes formed in the rubber plug G3. In this way, water intrusion along the wires 16 is suppressed. The rubber plug G3 may be pressed from outside by a pressing member 74 so as not to come out from the pull-out end part 54.

### <Concerning Shape of Exit Opening Edge Part of Base Holder>

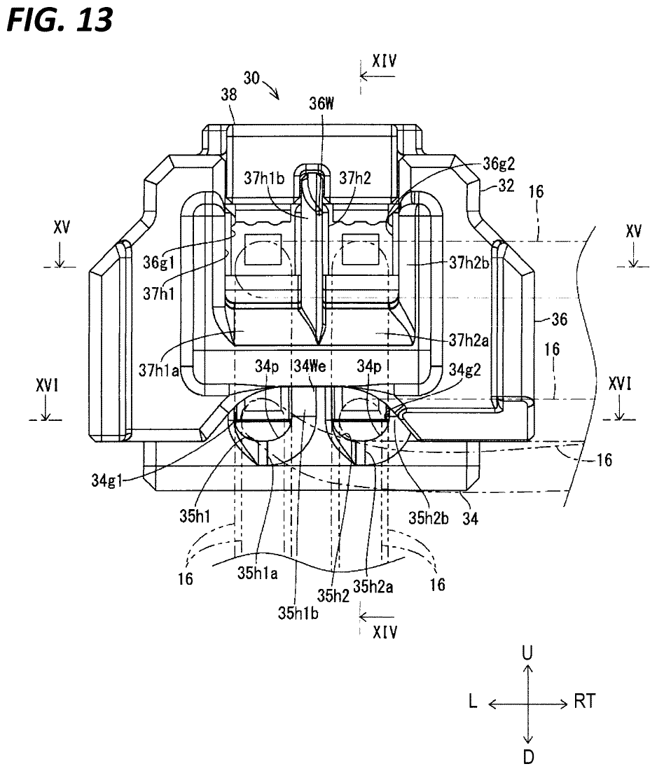

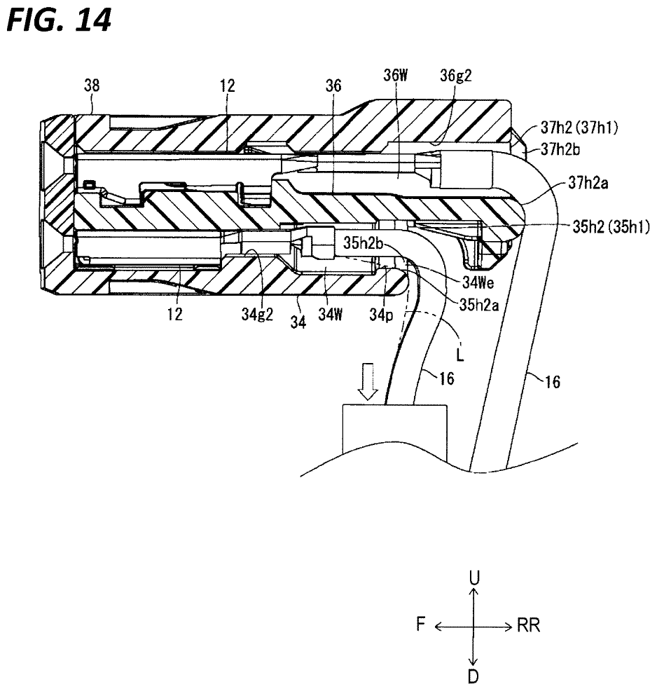

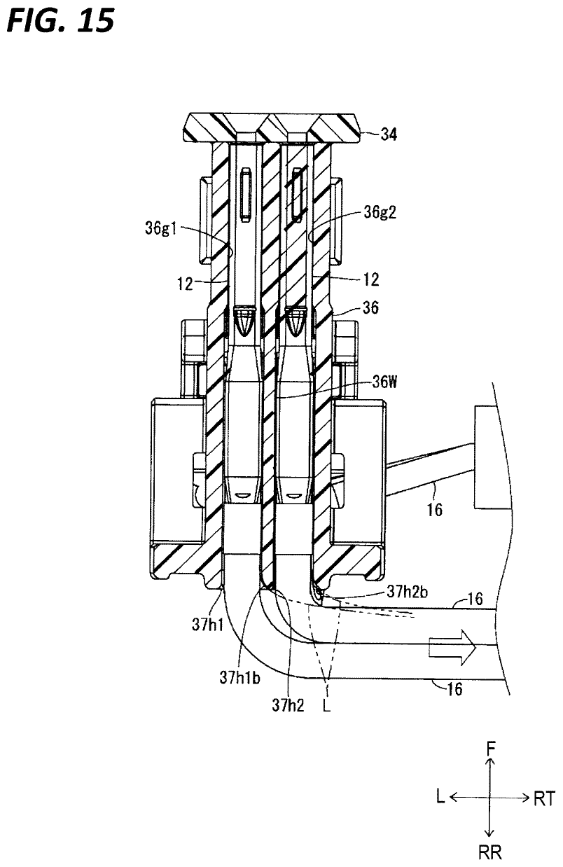

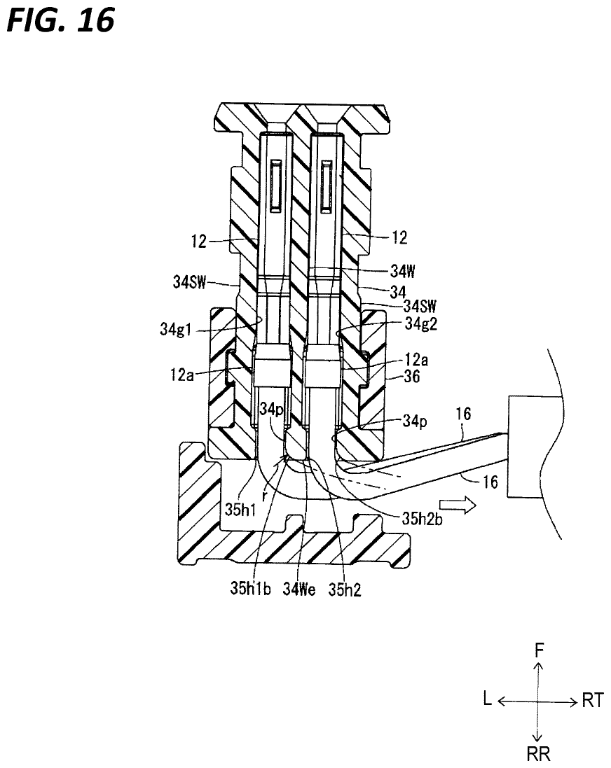

FIG. 13 is a back view of the terminal module 32. In FIG. 13, the wires 16 guided downward by the housing 50 are shown by two-dot chain lines and the wires 16 guided in the lateral direction by the housing 150 are shown by one-dot chain lines. FIG. 14 is a section along IVX-IVX of FIG. 13, FIG. 15 is a section along XV-XV of FIG. 13, and FIG. 16 is a section along XVI-XVI of FIG. 13. The cover member 70 is not shown in FIGS. 15 and 16.

As described above, the wires 16 coming out from the terminal holder 32 are guided in the direction intersecting the terminals 12 and the cavities 34g1, 34g2, 36g1 and 36g2 by the housing 50, 150. If the wire 16 is pulled, the wire 16 is possibly pressed against the exit opening edge part 35h1, 35h2, 37h1, 37h2.

The exit opening edge part 35h1, 35h2, 37h1, 37h2 has a convex curved surface 35h1a, 35h1b, 35h2a, 35h2b, 37h1a, 37h1b, 37h2a, 37h2b bent while forming a curved surface extending from the inner peripheral surface of the cavity 34g1, 34g2, 36g1, 36g2 in a direction intersecting an extension direction of the cavity 34g1, 34g2, 36g1, 36g2. In this way, if the wire 16 is pulled, this wire 16 is pressed against the convex curved surface 35h1a, 35h1b, 35h2a, 35h2b, 37h1a, 37h1b, 37h2a, 37h2b at the exit opening edge part 35h1, 35h2, 37h1, 37h2 (see a two-dot chain line L of FIGS. 14 and 15). Thus, a contact area of the wire 16 and the exit opening edge part 35h1, 35h2, 37h1, 37h2 increases and a force acting on the wire 16 is dispersed in a wide range.

The convex curved surface 35h1a, 35h1b, 35h2a, 35h2b, 37h1a, 37h1b, 37h2a, 37h2b may be, for example, a curved surface bent with a radius of curvature equal to or larger than an allowable bending radius of the wire 16. The allowable bending radius of the wire 16 is an allowable minimum radius of curvature to maintain performances of the wire 16. The allowable bending radius is regulated in a catalog and the like of the wire 16. As an example, the allowable bending radius may be a value, which is six times as large as the diameter of the wire 16.

The exit opening edge parts 35h1, 35h2 are surrounded by the rear opening edges of the cavities 34g1, 34g2 of the base holder 34 and parts of the lower edge of the rear side of the intermediate holder 36, and mainly formed in the base holder 34. When viewed from behind, the exit opening edge part 35h1 corresponds to the left cavity 34g1, and exit opening edge part 35h2 corresponds to the right cavity 34g2.

The convex curved surfaces 35h1a, 35h1b, 35h2a and 35h2b may be formed in parts of the entire peripheries of the respective exit opening edge parts 35h1, 35h2. That is, parts of the entire peripheries of the exit opening edge parts 35h1, 35h2 have a radius of curvature larger than those of the other parts, and these parts having a large radius of curvature may be the convex curved surfaces 35h1a, 35h1b, 35h2a and 35h2b.

The convex curved surfaces 35h1a, 35h1b may be located at positions different from each other in a circumferential direction of the exit opening edge part 35h1. The convex curved surfaces 35h2b, 35h2b may be located at positions different from each other in a circumferential direction of the exit opening edge part 35h2.

Here, out of the entire peripheries of the exit opening edge parts 35h1, 35h2, the convex curved surfaces 35h1a, 35h2a are formed on a side in the guiding direction by the wire guiding portion 52, and the convex curved surfaces 35h1b, 35h2b are formed on a side in the guiding direction by the wire guiding portion 152.

More specifically, the convex curved surfaces 35h1a, 35h2a are formed on a side opposite to the intermediate holder 36, out of the entire peripheries of the exit opening edge parts 35h1, 35h2. Thus, in the case of mounting the terminal module 30 into the housing 50 for guiding the wires 16 downward, the wires 16 guided downward are guided by way of the convex curved surfaces 35h1a, 35h2a. The wires 16 pulled downward are pressed against the convex curved surfaces 35h1a, 35h2a.

The convex curved surfaces 35h1b, 35h2b are formed on one side (here, right side) in an arrangement direction of the exit opening edge parts 35h1, 35h2, out of the entire peripheries of the exit opening edge parts 35h1, 35h2. The positions of the convex curved surfaces 35h1b, 35h2b in the entire peripheries of the exit opening edge parts 35h1, 35h2 are on one side in a direction intersecting both the extension direction of the cavities 34g1, 34g2 and an overlapping direction of the base holder 34 and the intermediate holder 36. Thus, in the case of mounting the terminal module 30 into the housing 150 for guiding the wires 16 rightward, the wires 16 guided rightward are guided by way of the convex curved surfaces 35h1b, 35h2b. The wires 16 pulled rightward are pressed against the convex curved surfaces 35h1b, 35h2b.

The convex curved surfaces 35h1a, 35h2a may be referred to as first convex curved surfaces, and the convex curved surfaces 35h1b, 35h2b may be referred to as second convex curved surfaces.

In the cavity 34g1, the first and second convex curved surfaces 35h1a, 35h1b are arcuately connected when viewed from behind along the extension direction of the cavity 34g1. An arcuately connected part of the first and second convex curved surfaces 35h1a, 35h1b is also formed into a convex curved surface extending from the inner periphery of the cavity 34g1 in an outward direction orthogonal to the extension direction of the cavity 34g1. That is, a coupled part of the convex curved surfaces 35h1b, 35h2b is formed into a conical shape. In this embodiment, the first convex curved surface 35h1a has an arcuate shape when viewed from behind. An upper part of the second convex curved surface 35h1b has a straight shape extending in the vertical direction, and a lower part has an arcuate shape. Thus, the first and second convex curved surfaces 35h2a, 35h2b are connected into a J shape when viewed from behind.

Similarly, the first and second convex curved surfaces 35h2a, 35h2b are also arcuately connected.

To increase a contact area with the wire 16, the convex curved surface 35h1a, 35h1b, 35h2a, 35h2b preferably has as large a radius of curvature as possible and as long an arc as possible. Accordingly, the base holder 34 of the terminal holder 32 includes thickening portions 34p. In this embodiment, the thickening portions 34p are parts formed by causing parts of the cavities 34g1, 34g2 on the side of the exit opening edge parts 35h1, 35h2 to project inwardly of the cavities 34g1, 34g2. More specifically, the thickening portions 34p are formed on bottom parts of the cavities 34g1, 34g2, both side parts of the partition wall 34W and an inward facing part of the side wall 34SW on one side (right side) (see FIGS. 14 and 16). The convex curved surface 35h1a, 35h1b, 35h2a, 35h2b is formed into a curved surface extending from the thickening portion 34p in an outward direction intersecting the extension direction of the cavity 34g1, 34g2.

By thickening the convex curved surfaces 35h1a, 35h1b, 35h2a and 35h2b by the thickening portions 34p, the convex curved surfaces 35h1a, 35h1b, 35h2a, 35h2b easily have a large radius of curvature and extend in a wide range. Further, it is suppressed than the terminal holder 32 is thinned in outer parts of the convex curved surfaces 35h1a, 35h1b, 35h2a and 35h2b.

Note that the thickening portions 34p may be formed in regions closer to the exit opening edge parts 35h1, 35h2 than regions where the terminals 12 are arranged, out of the cavities 34g1, 34g2 (see FIG. 16). The wires 16 are thinner than the wire connecting portions 12a of the terminals 12. By forming the thickening portions 34p in the above regions, the thickening portions 34p are easily formed while the enlargement of the terminal holder 32 is suppressed.

The following description is focused on the second convex curved surface 35h1b. The partition wall 34W includes an exit-side partitioning edge part 34We located between the first and second exit opening edge parts 35h1, 35h2. The second convex curved surface 35h1b is formed on a part of the exit opening edge part 35h1b, out of the first exit opening edge part 35h1 (see FIGS. 13 and 16).

The second convex curved surface 35h1b has a larger radius of curvature r than that of a part of the exit-side partitioning edge part 34We on the side of the second exit opening edge part 35h2. In other words, when the exit-side partitioning edge part 34We is viewed from above, a corner part of the first exit opening edge part 35h1, out of the exit-side partitioning edge part 34We, is bent at a larger radius of curvature r than a corner part on the side of the second exit opening edge part 35h2.

In this way, a presence region of the second convex curved surface 35h1b can be enlarged and a contact area of the wire 16 and the second convex curved surface 35h1b is easily increased as compared to the case where convex curved surfaces are formed on both sides of the exit-side partitioning edge part 34We.

The exit opening edge parts 37h1, 37h2 are surrounded by the rear opening edges of the cavities 36g1, 36g2 of the intermediate holder 36 and parts of the lower edge of the rear side of the cover holder 38, and mainly formed in the intermediate holder 36. When viewed from behind, the exit opening edge part 37h1 corresponds to the left cavity 36g1, and the exit opening edge part 37h2 corresponds to the right cavity 36g2.

The convex curved surfaces 37h1a, 37h1b, 37h2a and 37h2b may be formed in parts of the entire peripheries of the respective exit opening edge parts 37h1, 37h2. That is, parts of the entire peripheries of the exit opening edge parts 37h1, 37h2 have a radius of curvature larger than those of the other parts, and these parts having a large radius of curvature may be the convex curved surfaces 37h1a, 37h1b, 37h2a and 37h2b.

The convex curved surfaces 37h1a, 37h1b may be located at positions different from each other in a circumferential direction of the exit opening edge part 37h1. The convex curved surfaces 37h2a, 37h2b may be located at positions different from each other in a circumferential direction of the exit opening edge part 37h2.

Here, out of the entire peripheries of the exit opening edge parts 37h1, 37h2, the convex curved surfaces 37h1a, 37h2a are formed on a side in the guiding direction by the wire guiding portion 52, and the convex curved surfaces 37h1b, 37h2b are formed on the side in the guiding direction by the wire guiding portion 152.

More specifically, the convex curved surfaces 37h1a, 37h2a are formed on the side of the base holder 34, out of the entire peripheries of the exit opening edge parts 37h1, 37h2. Thus, in the case of mounting the terminal module 30 into the housing 50 for guiding the wires 16 downward, the wires 16 guided downward are guided by way of the convex curved surfaces 37h1a, 37h2a. The wires 16 pulled downward are pressed against the convex curved surfaces 37h1a, 37h2a.

The convex curved surfaces 37h1b, 37h2b are formed on one side (here, right side) in an arrangement direction of the exit opening edge parts 37h1, 37h2, out of the entire peripheries of the exit opening edge parts 37h1, 37h2. The positions of the convex curved surfaces 37h1b, 37h2b in the entire peripheries of the exit opening edge parts 37h1, 37h2 are on one side in a direction intersecting both the extension direction of the cavities 36g1, 36g2 and the overlapping direction of the base holder 34 and the intermediate holder 36. Thus, in the case of mounting the terminal module 30 into the housing 150 for guiding the wires 16 rightward, the wires 16 guided rightward are guided by way of the convex curved surfaces 37h1b, 37h2b. The wires 16 pulled rightward are pressed against the convex curved surfaces 37h1b, 37h2b.

The convex curved surfaces 37h1a, 37h2a may be referred to as first convex curved surfaces, and the convex curved surfaces 37h1b, 37h2b may be referred to as second convex curved surfaces.

In the cavity 36g1, the first and second convex curved surfaces 37h1a, 37h1b are connected into an L shape when viewed from behind along the extension direction of the cavity 36g1. Similarly, the first and second convex curved surfaces 37h2a, 37h2b are connected into an L shape.

Note that, in the case of applying the terminal holder 32 only for the housing 50 including the wire guiding portion 52, the convex curved surfaces 35h1a, 35h2a, 37h1a and 37h2a may be formed only on the side in the guiding direction by the wire guiding portion 52. For example, in the case of applying the terminal holder 32 only for the housing 150 including the wire guiding portion 152, the convex curved surfaces 35h1a, 35h2a, 37h1a and 37h2a may be formed only on the side in the guiding direction by the wire guiding portion 152. In the case of applying the terminal holder 32 for the both housings 50, 150, the convex curved surfaces 35h1a, 35h1b, 35h2a, 35h2b, 37h1a, 37h1b, 37h2a and 37h2b may be formed on the sides in the both guiding directions by the wire guiding portions 52, 152.

Similarly to the second convex curved surface 35h1b, the second convex curved surface 37h1b is formed on a part of the first exit opening edge part 37h1, out of a rear end edge part of the partition wall 36W partitioning between the cavities 36g1, 36g2 (see FIGS. 13 and 15).

In this way, a presence region of the second convex curved surface 37h1b can be enlarged and a contact area of the wire 16 and the second convex curved surface 37h1b is easily increased.

In the extension direction of the cavities 34g1, 34g2, 36g1 and 36g2, the exit opening edge parts 37h1, 37h2 of the intermediate holder 36 are located behind and outside the exit opening edge parts 35h1, 35h2 of the base holder 34. Thus, the wires 16 extending out from the exit opening edge parts 37h1, 37h2 and the wires 16 extending out from the exit opening edge parts 35h1, 35h2 are arranged to be shifted in the front-rear direction, and those wires 16 hardly interfere with each other. Particularly, if the wires 16 are pulled out downward, the wires 16 extending out from the exit opening edge parts 37h1, 37h2 are easily guided to pass behind the wires 16 extending out from the exit opening edge parts 35h1, 35h2. In this way, the wires 16 extending out from the exit opening edge parts 35h1, 35h2 are hardly strongly pressed against the exit opening edge parts 35h1, 35h2.

### Effects, Etc.

According to the connector 20, 120 configured as described above, if the wire 16 is pulled, the wire 16 can be pressed against the convex curved surface 35h1a, 35h1b, 35h2a, 35h2b, 37h1a, 35h1b, 37h2a, 37h2b of the exit opening edge part 35h1, 35h2, 37h1, 37h2. Since the contact area of the wire 16 and the exit opening edge part 35h1, 35h2, 37h1, 37h2 can be increased by the convex curved surface 35h1a, 35h1b, 35h2a, 35h2b, 37h1a, 35h1b, 37h2a, 37h2b, a force for pressing the wire 16 against the exit opening edge part 35h1, 35h2, 37h1, 37h2 of the cavity 34g1, 34g2, 36g1, 36g2 can be dispersed in as wide a range as possible.

Further, if the convex curved surface 35h1a, 35h1b, 35h2a, 35h2b, 37h1a, 35h1b, 37h2a, 37h2b is bent at a radius of curvature equal to or larger than the allowable bending radius of the wire 16, the wire 16 is hardly bent at a radius of curvature smaller than the allowable bending radius of the wire 16 and performances of the wires 16 are easily maintained.

Further, the convex curved surface 35h1b is formed on the side of the first exit opening edge part 35h1, out of the exit-side partitioning edge part 34We. If an attempt is made to form convex curved surfaces on both sides of the first and second exit opening edge parts of the exit opening edge parts, either each convex curved surface region is reduced or a partition wall is thickened. If each convex curved surface region is reduced, a force is dispersed in a narrower range. If the partition wall is thickened, it leads to the enlargement of the connector. Accordingly, focusing on the pull-out direction of the wires 16, the convex curved surface is formed on the part of the first exit opening edge part side, out of the exit-side partitioning edge part 34We, assuming a case where the wire 16 extending out from the first exit opening edge part 35h1 is guided toward the second exit opening edge part 35h2. In this way, a force for pressing the wire 16 coming out from the cavity 34g1 against the exit-side partitioning edge part 34We can be dispersed in as wide a range as possible while the enlargement of the connector 20 is suppressed.

By similarly forming the convex curved surface 37h1b, a force for pressing the wire 16 against the right side of the first exit opening edge part 37h1 of the cavity 36g1 can be dispersed in as wide a range as possible.

Further, since the terminal holder 32 includes the thickening portions 34p and the convex curved surfaces 35h1a, 35h1b, 35h2a and 35h2b are formed into curved surfaces extending from the thickening portions 34p in the outward direction intersecting the extension direction of the cavities 34g1, 34g2, the convex curved surfaces 35h1a, 35h1b, 35h2a and 35h2b are easily enlarged.

Further, since the thickening portions 34p are formed closer to the exit opening edge parts 35h1, 35h2 than the regions where the terminals 12 are arranged, regions where the wires 16 thinner than the wire connecting portions 12a pass can be utilized. In this way, the thickening portions 34p can be formed while the enlargement of the terminal holder 32 is suppressed.

Further, the exit opening edge parts 37h1, 37h2 of the intermediate holder 36 are shifted from the exit opening edge parts 35h1, 35h2 of the base holder 34 in the extension direction (front-rear direction) of the cavities 34g1, 34g2, 36g1 and 36g2. Thus, the wires 16 extending out from the exit opening edge parts 37h1, 37h2 hardly interfere with the wires 16 extending from the exit opening edge parts 35h1, 35h2. Thus, the wires 16 extending out from the base holder 34 are easily stably pressed against the convex curved surfaces 35h1a, 35h1b, 35h2a and 35h2b of the base holder and the wires 16 extending out from the intermediate holder 36 are easily stably pressed against the convex curved surfaces 37h1a, 37h1b, 37h2a and 37h2b.

Particularly, the exit opening edge parts 37h1, 37h2 of the intermediate holder 36 are located behind and outside the exit opening edge parts 35h1, 35h2 of the base holder 34. Thus, if the wires 16 are guided in the same direction as a direction from the intermediate holder 36 toward the base holder 34, the wires 16 respectively extending out from the intermediate holder 36 and the base holder 34 are stably pressed against the convex curved surfaces 35h1a, 35h2a, 37h1a and 37h2a while mutual interference is avoided.

Further, since the convex curved surfaces 35h1b, 35h2b, 37h1b and 37h2b are formed on the lateral sides (right sides) of the respective exit opening edge parts 35h1, 35h2, 37h1 and 37h2, the wires 16 pulled out in the lateral direction are easily stably pressed against the convex curved surfaces 35h1b, 35h2b, 37h1b and 37h2b while mutual interference is avoided.

Further, the convex curved surface 35h1a, 35h2a, 37h1a, 37h2a and the convex curved surface 35h1b, 35h2b, 37h1b, 37h2b are located at positions different from each other in the circumferential direction of the cavity 34g1, 34g2, 36g1, 36g2. Thus, if the terminal holder 32 is configured to be selectively mounted into the housings 50, 150 having different pull-out directions, a force for pressing the wire 16 against the exit opening edge part of the cavity 34g1, 34g2, 36g1, 36g2 can be dispersed in as wide a range as possible regardless of in which direction the wire 16 is guided.

Further, since the convex curved surface 35h1a, 35h2a and the convex curved surface 35h1b, 35h2b are arcuately connected, the wire 16 contacts the arcuately connected part of those in a larger contact area. Thus, a force for pressing the wire 16 against the exit opening edge part of the cavity 34g1, 34g2 can be dispersed in a wider range.

### [Modifications]

The configuration of the terminal holder 32 to be held in the connectors 20, 120 is not limited to the above example. A terminal holder may not be configured by uniting a plurality of the holders 34, 36, 36. For example, a holder may include a housing having cavities and a retainer, and terminals inserted into the cavities may be retained by the retainer.

The number of the terminals to be held in the terminal holder is arbitrary. A multitude of terminals may be held in a width direction or terminals may be held in more stages in the terminal module.

Note that the respective configurations described in the above embodiment and each modification can be approximately combined without contradicting each other.

### LIST OF REFERENCE NUMERALS

11 terminal-equipped wire
12 terminal
12a wire connecting portion
12b terminal connecting portion
12g recess
16 wire
20, 120 connector
30 terminal module
30P protrusion
32 terminal holder
33 locking recess
34 base holder
34FW front wall
34SW, 36SW side wall
34W, 36W partition wall
34We exit-side partitioning edge part
34g1, 36g1 first cavity (cavity)
34g2, 36g2 second cavity (cavity)
34gp, 36gp positioning protrusion
34p thickening portion
34r1, 34r2 locking protrusion
35h1, 37h1 first exit opening edge part (exit opening edge part)
35h2, 37h2 second exit opening edge part (exit opening edge part)
35h1a, 35h2a, 37h1a, 37h2a first convex curved surface (convex curved surface)
35h1b, 35h2b, 37h1b, 37h2b second convex curved surface (convex curved surface)
36 intermediate holder
36p locking piece
38 cover holder
38p locking piece
50, 150 housing
50p1, 150p1 locking protrusion
52, 152 wire guiding portion
52h, 152h setting opening
54 pull-out end part
60 holder holding portion
61 coupling wall
62 accommodation wall portion
62S terminal component accommodation space
62a first opening
62b second opening
62p mounting protrusion
63 side wall
64 upper wall
65 lower wall
66 locking lance
66P base end
67 locking protrusion
67f1 guide surface
68 outer wall portion
68a lock piece
70 cover member
71 cover body
72 locking piece
74 pressing member
90 retainer
91 front wall
92 peripheral wall
92g mounting recess
94 restricting portion
G1, G2 annular resilient member
G3 rubber plug
S slit
r radius of curvature

1. A connector for holding a terminal via a terminal holder, comprising:
a terminal-equipped wire including a wire and the terminal mounted on an end part of the wire;
the terminal holder including a cavity for holding the terminal; and
a housing including a holder holding portion for holding the terminal holder and a wire guiding portion for guiding the wire extending out from the holder holding portion,
the terminal holder including an exit opening edge part for allowing the wire to extend out from the cavity, and
the exit opening edge part having a convex curved surface bent while forming a curved surface extending from an inner peripheral surface of the cavity in a direction intersecting an extension direction of the cavity.

2. The connector of claim 1, wherein the convex curved surface is bent at a radius of curvature equal to or larger than an allowable bending radius of the wire.

3. The connector of claim 1, wherein:
the cavities include a first cavity and a second cavity arranged in parallel,
the exit opening edge parts include a first exit opening edge part and a second exit opening edge part respectively corresponding to the first and second cavities,
the terminal holder further includes a partition wall partitioning between the first and second cavities,
the partition wall includes an exit-side partitioning edge part located between the first and second exit opening edge parts,
the convex curved surface is formed on a part of the first exit opening edge part side, out of the exit-side partitioning edge part, and
the convex curved surface has a larger radius of curvature than a part of the second exit opening edge part side, out of the exit-side partitioning edge part.

4. The connector of claim 1, wherein:
the terminal holder includes a thickening portion for causing a part on the exit opening edge part side, out of the cavity, to project inwardly of the cavity, and
the convex curved surface is a curved surface extending from the thickening portion in a direction intersecting the extension direction of the cavity.

5. The connector of claim 4, wherein the thickening portion is formed in a region closer to the exit opening edge part than a region of the cavity where the terminal is arranged.

6. The connector of claim 1, wherein:
the terminal holder includes a base holder and an intermediate holder to be overlapped on the base holder,
each of the base holder and the intermediate holder is formed with the cavity and the exit opening edge part, and
the exit opening edge part of the intermediate holder is located to be shifted from the exit opening edge part of the base holder in the extension direction of the cavities.

7. The connector of claim 6, wherein:
the exit opening edge part of the intermediate holder is located more outward than the exit opening edge part of the base holder in the extension direction of the cavities,
the convex curved surface is formed on a side opposite to the intermediate holder, out of the exit opening edge part of the base holder, and
the convex curved surface is formed on the base holder side, out of the exit opening edge part of the intermediate holder.

8. The connector of claim 6, wherein each of the exit opening edge part of the base holder and the exit opening edge part of the intermediate holder is formed with the convex curved surface on a side in a direction intersecting both the extension direction of the cavities and an overlapping direction of the base holder and the intermediate holder.

9. The connector of claim 1, wherein:
the convex curved surfaces include a first convex curved surface and a second convex curved surface, and
the first and second convex curved surfaces are formed at positions different from each other in a circumferential direction of the exit opening edge part.

10. The connector of claim 9, wherein the first and second convex curved surfaces are arcuately connected when viewed from the exit opening edge part side along the extension direction of the cavity.
